(19) United States
(12) Patent Application Publication
(10) Pub. No.: US 2009/0228427 A1
(43) Pub. Date: Sep. 10, 2009

(54) MANAGING DOCUMENT WORK SETS

(75) Inventors: Dustin Friesenhahn, Seattle, WA (US); Ethan D. Gur-esh, Seattle, WA (US); Adrian Fanaru, Sammamish, WA (US); Nathan J. Fink, Seattle, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 12/043,794

(22) Filed: Mar. 6, 2008

(51) Int. Cl. G06F 17/30; G06F 9/46

(52) U.S. Cl. 707/1; 718/102; 707/E17.001

(57) ABSTRACT

A document work set acts as a document container for items that are associated with a work product. A document work set is created from a document work set template that defines properties and workflows that are associated with the document work set. Metadata is shared between the items in the document work set and workflows may be associated with the document work set as well as the individual items within the work set. Instead of just providing a view of the items in the work set when accessed, information relating to the overall work product that is represented by the document work set is displayed.

### BACKGROUND

There are many different ways to store items on a computer system. For instance, folders are commonly used to store items such as documents, graphics and other files. Document libraries may be created to act as a central repository for documents that are shared among a group of users. The folders and document libraries provide a way to organize and structure their contents. For example, items in a folder or document library may be arranged by date of creation, date of editing, size, location, and the like.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A document work set acts as a document container for items that are associated with a work product. A document work set template defines properties, such as default content and/or metadata, for instances of the document work set. Metadata is shared between the items in the document work set and workflows may be associated with the document work set as well as the individual items within the work set. Instead of just providing a view of the items in the work set when accessed, information relating to the overall work product that is represented by the document work set is displayed.

### BRIEF DESCRIPTION OF THE DRAWINGS

FIG. 1 illustrates an exemplary computing device;

FIG. 2 shows a document work set system; and

FIG. 3 shows an illustrative process for creating a document work set.

### DETAILED DESCRIPTION

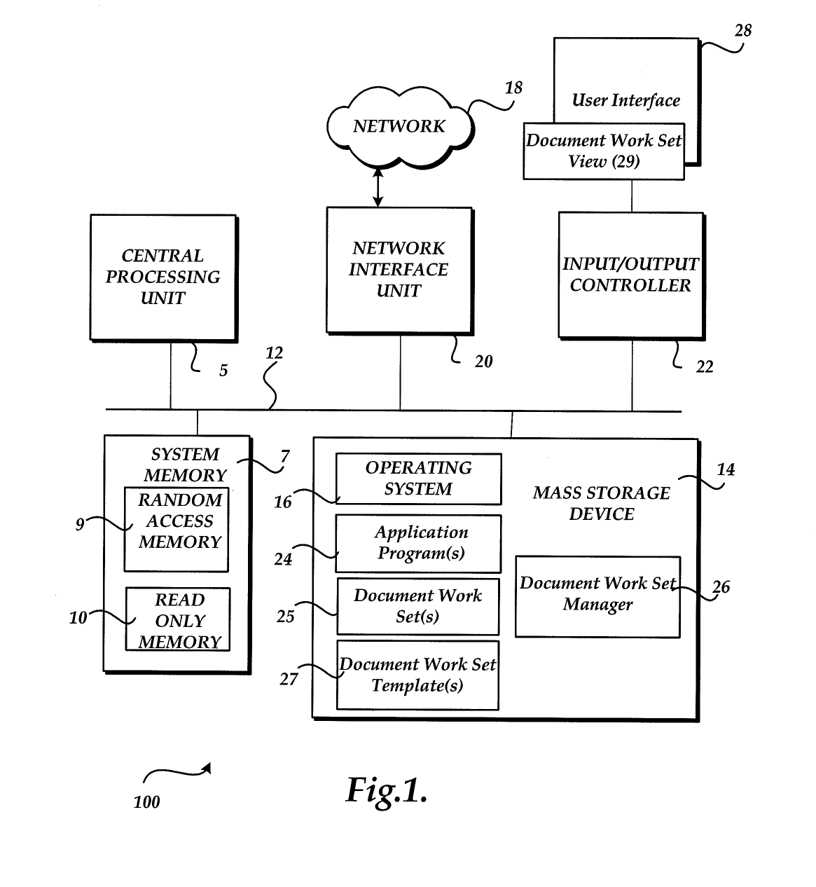

Referring now to the drawings, in which like numerals represent like elements, various embodiment will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer architecture for a computer 100 utilized in the various embodiments will be described. The computer architecture shown in FIG. 1 may be configured as a desktop or mobile computer and includes a central processing unit 5 (“CPU”), a system memory 7, including a random access memory 9 (“RAM”) and a read-only memory (“ROM”) 10, and a system bus 12 that couples the memory to the CPU 5. A basic input/output system containing the basic routines that help to transfer information between elements within the computer, such as during startup, is stored in the ROM 10. The computer 100 further includes a mass storage device 14 for storing an operating system 16, application programs 24, and other program modules, which will be described in greater detail below.

The mass storage device 14 is connected to the CPU 5 through a mass storage controller (not shown) connected to the bus 12. The mass storage device 14 and its associated computer-readable media provide non-volatile storage for the computer 100. Although the description of computer-readable media contained herein refers to a mass storage device, such as a hard disk or CD-ROM drive, the computer-readable media can be any available media that can be accessed by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100.

According to various embodiments, computer 100 may operate in a networked environment using logical connections to remote computers through a network 18, such as the Internet. The computer 100 may connect to the network 18 through a network interface unit 20 connected to the bus 12. The network connection may be wireless and/or wired. The network interface unit 20 may also be utilized to connect to other types of networks and remote computer systems. The computer 100 may also include an input/output controller 22 for receiving and processing input from a number of other devices, including a keyboard, mouse, or electronic stylus (not shown in FIG. 1). Similarly, an input/output controller 22 may provide output to a display screen including a user interface (UI) 28, a printer, or other type of output device.

As mentioned briefly above, a number of program modules and data files may be stored in the mass storage device 14 and RAM 9 of the computer 100, including an operating system 16 suitable for controlling the operation of a networked computer, such as the WINDOWS VISTA operating system from MICROSOFT CORPORATION of Redmond, Wash. A document collaboration system, such as WINDOWS SHAREPOINT SERVICES (WSS) from MICROSOFT CORPORATION of Redmond, Wash. may also be utilized in embodiments of the invention. The mass storage device 14 and RAM 9 may also store one or more program modules. In particular, the mass storage device 14 and the RAM 9 may store one or more application programs 24, such as a browser application and a document collaboration application (not shown). The document work set manager 26 is operative to provide services relating to managing document work sets. According to one embodiment, document work set manager 26 operates in conjunction with a document collaboration application, such as WSS.

Although document work set manager 26 is shown separately from application programs 24, it may be included directly within an application program 24 or at some other location. For example, the document work set manager 26 may be included directly within a document collaboration program, a file system application, the operating system 16, and the like. The operation of document work set manager 26 will be described in more detail below.

Generally, document work set manager 26 is configured to manage document work sets 25 that are created from document work set templates 27. A document work set 25 acts as a document container for items that are associated with a work product. A user creates an instance of a document work set 25 from a document work set template 27. Document work set template(s) 27 provides a template that is utilized to create a document work set. The document work set template 27 allows customization of elements that are associated with the document work set, including but not limited too: setting restrictions regarding the document work set (i.e. allowed content types for new items); specifying default content for the document work set; setting the metadata/properties about the overall set that are automatically shared between all of the items in the work product; specifying workflows; specifying a view page that provides a view of the document work set; and the like.

A document work set 25 is an instance of a document work set template. The document work set 25 is pre-populated with a set of documents specified by its template, with the document work set view page specified by the template, restricted for new documents (items) to a particular set of content types and with the metadata synchronization behavior defined in the associated document work set template. User input may also be combined with the template definition to customize the set of documents.

When a document work set is accessed, a document work set view page 29 may be displayed to the user. Instead of just providing a view of the items in the work set, such as a folder view, the welcome page displays information relating to the overall work product that is represented by the document work set. According to one embodiment, document work sets are represented by a single icon. The icon provides an overall view of the document work set instead of a view inside the document work set. Other ways of representing the work set may also be utilized. For example, a standard naming scheme could be used to represent document work sets. The document work set view page 29 may be customized such that elements on the page may be easily changed. Page 29 may also be used to set restrictions to the document work set. For example, the restrictions may related to what items may be added to the document work set, what items are automatically part of the document work set, and the like. Document work set manager 26 is described in more detail below.

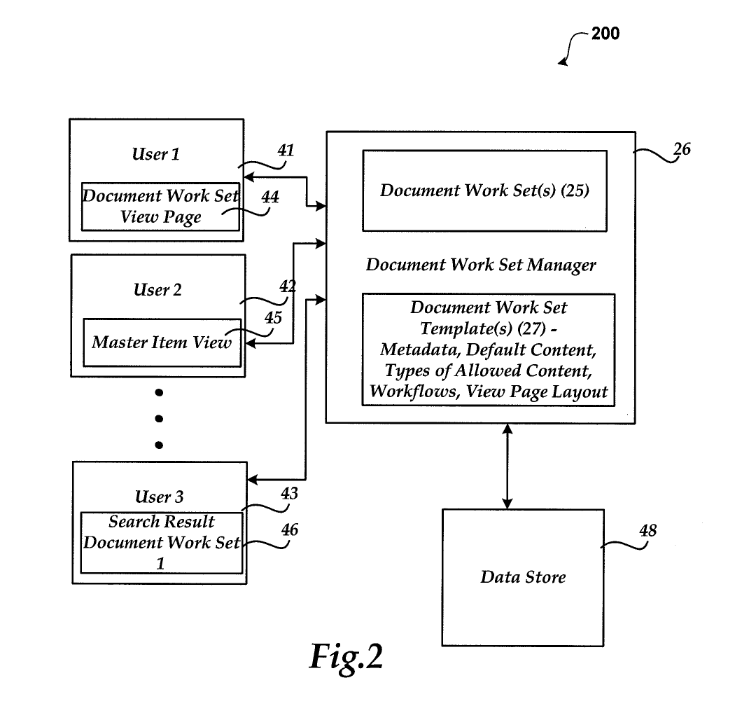

FIG. 2 shows a document work set system 200. As illustrated, document work set system 200 includes document work set manager 26, document work set templates 27, document work sets 25, users 1-3 (41-43), document work set view page 44, master item view 45, search result 46 and data store 48.

As discussed above, document work set manager 26 provides services for document work sets. A document work set is directed at representing an end work product. For example, a document work set may be created to represent an end deliverable. The items contained within the document work set may be stored together, such as in data store 48, or some of the items may be located separately from the other items. For example, one or more of the items may be a reference to an item (e.g. a link to a reference that is not physically stored with the other items in the document work set).

Document work set template(s) provide an easy way for end-users to create new document work sets using defined work set templates. As such, the end-users are not required to perform administrative actions (which they may not have the rights to perform) or manually have to configure settings. A user, such as User 1, may interact with an instance of a document work set as though it were a single item. For example, a user could create a new version, publish the work product, move, copy, import, export, archive, associate workflows with the document work set, and the like. Even though a document work set may be treated as a single item, performing an action on the item may result in the items within the document work set also being treated. For example, creating a new version may not only change the version of the document work set, but also change the versions of the items comprising the work set. According to one embodiment, document work set templates include descriptions of the metadata to be synchronized between all of the items in the document work set as well as the document work set itself. The template also includes a list of allowed content types that may be included in the document work set. The document work set template also defines default content that is created in the document work set at creation time. For example, a set of files may be defined that is automatically copied/added to each instance of the document work set when its created. A view of the document work set may also be defined. Instead of just showing contents of the document work set, the view may show other information relating to the document work set. For example, the view may show items in the document work set, workflows associated with the items and the document work set.

An item within the document work set may be designated as the master item. Generally, the master item is an item in the document work set that represents the overall work product, or deliverable, of the document work set. For example, a final paper that is published in the document work set may be considered a master item. According to one embodiment, the document work set is viewed differently by users who are part of creating the work product and those users who are not involved in the work product. In this embodiment, the master item 45 is displayed to users who are not involved in the development of the work product instead of displaying the document work set view page that provides the user with more control over the document work set.

An example will now be provided for clarification purposes which is not intended to be limiting. Suppose that an investment firm repeatedly creates pitchbooks. Without utilizing document work sets, the firm would have to develop a custom solution to help in creating the pitchbooks. Instead of having to create custom solutions, employees of the firm may easily create a pitchbook document work set from a predefined document work set template. When the employee creates a new pitchbook document work set, they specify the appropriate metadata (Customer ID, billing system info, etc.) to share for this pitchbook instance. The pitchbook document work set template automatically creates a new pitchbook, including creating the appropriate sections of the pitchbook that need to be authored using the appropriate document templates as specified within the pitchbook document work set template. Following the pitchbook document work set template, the employee can assign ownership of each section to a member of the team and start a workflow to have each member author their section. If the document work set manager functionality is incorporated with a content management system then the members of the team can author their sections while taking advantage of the functionality of the content management system, such as versioning, content reuse, and the like. Additionally, since each item in the document work set is associated with the other items in the document work set through metadata information about those other sections is available to them in-context while they are authoring their assigned section. For example, a user could determine the workflow status of the other sections being authored. When they are done authoring their section, they each mark their workflow task as complete. The work-product associated with this example is a pitchbook which may be published into a single file to deliver to the potential customer. This pitchbook may be designated as the master item of the document work set.

According to one embodiment, the document work set's metadata is updated each item in the document work set is accessed to help ensure that each item has the same metadata as the document work set for the synchronized metadata fields. Additionally, when an individual item is updated within the document work set a check is made to determine if its metadata values are synchronized with the document work set to help ensure that all items stay synchronized with the document work set.

Returning search results related to a document work set is also performed differently as compared to traditional search methods. Referring now to User 3 in FIG. 2, suppose that User 3 performs a search for an item that is contained within a document work set. If the item is found within a document work set, then the document work set itself is returned as the search result 46 instead of just returning the found item. In this way, User 3 is provided with the work-product that is associated with the item instead of the discrete item. Should User 3 desire to access the individual item they could access the document work set view page.

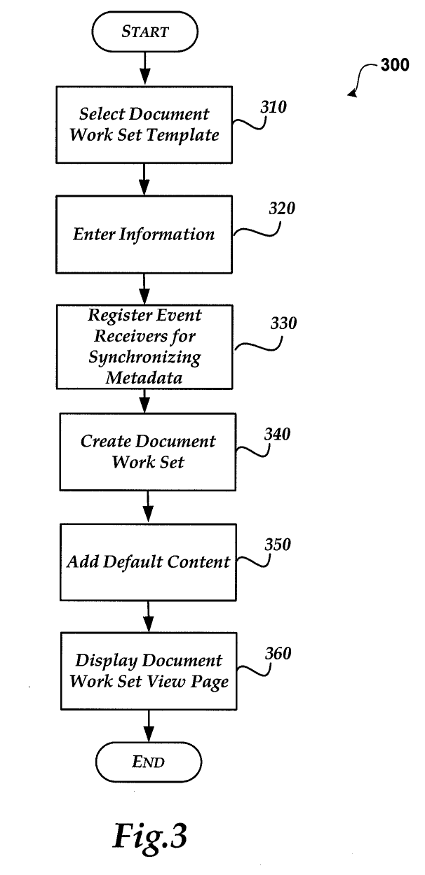

Referring now to FIG. 3, an illustrative process for creating a document work set is described.

When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

After a start operation, the process 300 flows to operation 310, where the user selects the document work set template to use to create an instance of a document work set.

Once selected, the process flows to operation 320, where the user is queried to enter any information that is requested from the template. The information may be used to make modifications to the default content of the document work set. The template generally defines the allowed content types for items that are contained within the document work set; the default content to add; the metadata to share between the document work set and the items within the document work set; the layout of the document work set view and the like. A user may make modifications to the template to create a new document work set template and/or modify an existing document work set template.

Moving to operation 330, event receivers for synchronization of the synchronized fields are registered. According to one embodiment, there are predefined receivers for when an item is added, when an item is updated, when an is checked in and when changes are made to the document work set. For events on the document work set and items within the document work set, the event receiver loops through the items in the document work set to help ensure that the items have the same metadata as the document work set.

Moving to operation 340, the document work set is created. According to one embodiment, this involves creating a folder to store the document work set items that comprise the document work set. Other ways may also be used to store the content. For example, items may be linked by storing a list of the items in the document work set.

Transitioning to operation 350, the default content items specified in the template for the document work set are added to the newly created document work set. For example, individual sections of a document to be authored may be created. Additionally, as stated above, workflows may be associated with one or more of the items and/or the document work set.

Moving to operation 360, the document work set view page is displayed. The process then flows to an end operation and returns to processing other actions.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for managing a document work set that contains items and is associated with a work product, comprising:
accessing a document work set template that defines: allowed content types for the document work set; default content for the document work set; and metadata for the document work set; wherein the metadata is shared between the document work set and each of the items that is contained within the document work set; and
creating the document work set from the document work set template; wherein the items contained in the document work set are used to create the work product.

2. The method of claim 1, further comprising associating a work flow with the document work set.

3. The method of claim 2, further comprising associating a second work flow with at least one of the items that is contained within the document work set.

4. The method of claim 1, further comprising returning the document work set instead of returning an item when a search would have returned the item within the document work set.

5. The method of claim 1, further comprising defining a page view that is used to view the document work set; wherein the page view includes controls to manage the document work set including adding items, deleting items, and changing properties of the document work set.

6. The method of claim 1, further comprising designating one of the items in the document work set as the master item; wherein only the master item within the document work set is displayed to a user who is not a part of the creation of the work product that is associated with the document work set.

7. The method of claim 4, wherein the items in the document work set include a link to a document that is not stored physically within the document work set.

8. The method of claim 1, further comprising providing an assembly function that automatically creates the master item in the list from other items that are contained within the document work set.

9. The method of claim 1, further comprising associating a single icon with the document work set; wherein a page view of the document work set is displayed to a user when the icon is selected by the user who is a part of a group that creates the work product and a single master item within the document work set is displayed to the user when the user is not part of a group that creates the work product.

10. A computer-readable storage medium having computer-executable instructions for managing a document work set that contains items and is associated with a work product that is created by a group of users, comprising:
accessing a document work set template that defines: allowed content types for the document work set; permissions for the document work set; default content for the document work set; workflows that are associated with the document work set and at least one item within the document work set; and shared metadata for the document work set; wherein the metadata is shared between the document work set and each of the items that is contained within the document work set; and
creating the document work set from the document work set template; wherein creating the document work set includes populating the document work set with the default content; setting the permissions for the document work set; defining a page view for the document work set; and associating the workflows with the at least one item and the document work set; wherein the items contained in the document work set are used to create the work product.

11. The computer-readable storage medium of claim 10, further comprising in response to a search, returning the document work set instead of returning the item when the search would have returned the item.

12. The computer-readable storage medium of claim 10, further comprising designating one of the items in the document work set as a master item; wherein only the master item within the document work set is displayed to a user who is not a part of the group of user who create the work product that is associated with the document work set.

13. The computer-readable storage medium of claim 10, wherein the items in the document work set include a link to an item that is not stored physically within the document work set.

14. The computer-readable storage medium of claim 10, further comprising associating a single icon with the document work set; wherein a page view of the document work set is displayed to a user when the icon is selected by the user who is a part of a group that creates the work product and a single master item within the document work set is displayed to the user when the user is not part of a group that creates the work product.

15. The computer-readable storage medium of claim 10, further comprising determining when an item is added to the document work set and in response to the item being added, synchronizing the metadata of the item with the other items in the document work set along with the metadata of the document work set.

16. A system for managing a document work set that contains items and is associated with a work product that is created by a group of users, comprising:
a processor and a computer-readable medium;
an operating environment stored on the computer-readable medium and executing on the processor;
a data store that is configured to store content and a document work set template; wherein the document work set defines: allowed content types for an instance of a document work set; permissions for the instance of the document work set; default content for the instance of the document work set; workflows that are associated with the instance of the document work set and at least one item within the instance of the document work set; and shared metadata for the instance of the document work set; wherein the metadata is shared between the instance of the document work set and each of the items that is contained within the instance of the document work set; and
a document work set manager that is configured to:
create the document work set from the document work set template; wherein creating the document work set includes populating the document work set with the default content; wherein the default content includes a link to an item that is not physically stored with the document work set; setting the permissions for the document work set; defining a page view for the document work set; and associating the workflows with the at least one item and the document work set; wherein the items contained in the document work set are used to create the work product.

17. The system of claim 16, further comprising in response to a search for an item within the document work set, returning the document work set instead of returning the item.

18. The system of claim 16, further comprising designating one of the items in the document work set as a master item; wherein only the master item within the document work set is displayed to a user who is not a part of the group of user who create the work product that is associated with the document work set.

19. The system of claim 16, further comprising associating a single icon with the document work set; wherein a page view of the document work set is displayed to a user when the icon is selected by the user who is a part of a group that creates the work product and a single master item within the document work set is displayed to the user when the user is not part of a group that creates the work product.

20. The system of claim 16, further comprising determining when an item is added to the document work set and in response to the item being added, synchronizing the metadata of the item with the other items in the document work set along with the metadata of the document work set.
